(19) United States
(12) Patent Application Publication
(10) Pub. No.: US 2022/0311012 A1
(43) Pub. Date: Sep. 29, 2022

(54) ELECTRODE PLATE, ELECTROCHEMICAL APPARATUS, AND ELECTRONIC APPARATUS

(71) Applicant: Ningde Amperex Technology Limited, Ningde (CN)

(72) Inventor: Luran ZHANG, Ningde (CN)

(73) Assignee: Ningde Amperex Technology Limited, Ningde (CN)

(21) Appl. No.: 17/708,309

(22) Filed: Mar. 30, 2022

Related U.S. Application Data
(63) Continuation of application No. PCT/CN2022/070377, filed on Jan. 5, 2022.

(30) Foreign Application Priority Data
Mar. 25, 2021 (CN) 202110320955.5

(51) Int. Cl. H01M 4/66

(52) U.S. Cl. CPC H01M 4/667; H01M 2004/021

(57) ABSTRACT

An electrode plate includes a current collector, where a functional coating and a non-coating area are provided on at least one surface of the current collector, the functional coating includes a functional area and an extension area that extends from the functional area to the non-coating area, and the extension area has a minimum thickness greater than 0 and a maximum thickness less than a thickness of the functional area. This relieves the problem of concentrated stress on the current collector in a transition area between the functional coating and the non-coating area on the electrode plate and improve mechanical property and a current conduction effect of the current collector, thereby improving properties such as cycling performance and safety of the electrochemical apparatus.

### CROSS REFERENCE TO THE RELATED APPLICATIONS

This application is a bypass continuation application of PCT application PCT/CN2022/70377, filed on Jan. 5, 2022, which claims priority to Chinese Patent Application No. 202110320955.5 filed on Mar. 25, 2021, the entire contents of which are incorporated herein by reference.

### TECHNICAL FIELD

This application relates to the field of electrochemical apparatuses, and in particular, to an electrode plate, an electrochemical apparatus, and an electronic apparatus.

### BACKGROUND

Electrochemical apparatuses such as lithium-ion secondary batteries are widely applied. Scientific and technological development is accompanied by higher requirements for energy density of electrochemical apparatuses. To guarantee or increase the energy density of an electrochemical apparatus, an electrode plate coating generally needs a higher compacted density. Therefore, high pressure needs to be exerted during a cold pressing manufacturing process of an electrode plate. Existing electrode plates are generally manufactured with gap coating. That is, a functional coating and a non-coating area are present on a surface of a current collector then the current collector is slit along the non-coating area to electrode plates. The manufactured electrode plate has a functional coating and a non-coating area. Due to a thickness difference of the functional coating and the non-coating area, when the electrode plate experiences relatively high external pressure (such as the pressure during the cold pressing manufacturing process or other external pressure), concentrated stress caused by the foregoing pressure is present in a part (or a transition area) of the functional coating in proximity of the non-coating area, causing irreversible deformation to the current collector in the transition area, thereby weakening mechanical properties of the current collector and affecting a current conduction effect in the electrochemical apparatus.

### SUMMARY

This application provides an electrode plate, an electrochemical apparatus, and an electronic apparatus, which resolve the problem that concentrated stress is present in a transition area of an electrode plate coating in proximity of a non-coating area during a cold pressing manufacturing process in the prior art, causing problems such as poor mechanical properties and a poor current conduction effect of a current collector.

According to one aspect of this application, an electrode plate is provided, including a current collector, where a functional coating and a non-coating area are provided on at least one surface of the current collector. The functional coating includes a functional area and an extension area that extends from the functional area to the non-coating area. The extension area has a minimum thickness greater than 0 and a maximum thickness less than a thickness of the functional area.

According to an embodiment of this application, the non-coating area includes at least one of a naked foil area that is located on a side of the functional coating, and a groove that is provided in the functional coating and that exposes a surface of the current collector, where a bottom face of the groove is the current collector, and at least two side faces of the groove are the functional coating.

According to an embodiment of this application, a thickness of the extension area is substantially unchanged or decreasing in an extension direction toward the non-coating area.

According to an embodiment of this application, a width of the extension area ranges from 0.1 mm to 3 mm in a direction from the functional area to the non-coating area.

According to an embodiment of this application, in the direction from the functional area to the non-coating area, a thickness of the extension area at a ½ width position is less than a thickness at a joint of the extension area and the functional area.

According to an embodiment of this application, in the direction from the functional area to the non-coating area, a thickness of a ⅔ width position of the extension area is less than a thickness of a ⅓ width position of the extension area.

According to an embodiment of this application, a surface of the extension area is one of a flat surface, an inclined surface, and a cambered surface.

According to an embodiment of this application, the functional area has an even thickness which satisfies

$$0.1 \leq \frac{{T}_{2}}{{T}_{1}} \leq 0.7 ,$$

where T₁ is the thickness of the functional area, and T₂ is the minimum thickness of the extension area.

According to an embodiment of this application, the thickness of the functional area ranges from 50 μm to 150 μm.

According to an embodiment of this application, the minimum thickness of the extension area ranges from 10 μm to 70 μm.

According to an embodiment of this application, the electrode plate is a negative electrode plate that satisfies

$${T}_{1} \times CW = A \times W \times \frac{{T}_{2}}{{T}_{1}} ;$$

or the electrode plate is a positive electrode plate that satisfies

$${T}_{1} \times CW = B \times W \times \frac{{T}_{2}}{{T}_{1}} ;$$

where T₁ is me thickness of the functional area, measured in μm; T₂ is the minimum thickness of the extension area, measured in μm; W is a width of the extension area in a direction from the functional area to the non-coating area, measured in mm; CW is a surface density of the functional area, measured in mg/1540.25 mm²; A is a random number greater than or equal to 10 and less than or equal to 35; and B is a random number greater than or equal to 20 and less than or equal to 60.

According to another aspect of this application, an electrochemical apparatus is provided, including the foregoing electrode plate.

According to still another aspect of this application, an electronic apparatus is provided, including the foregoing electrochemical apparatus.

With the foregoing electrode plate structure design of this application, when the electrode plate experiences external pressure, no excessive pressure is present in the extension area (the transition area of the functional area in proximity of the non-coating area), so that concentrated stress on the transition area can be relieved, avoiding deformation of the current collector and guaranteeing mechanical properties of the current collector and a current conduction effect in the electrochemical apparatus, thereby improving properties such as cycling performance, safety, and service life of the electrochemical apparatus. In addition, while guaranteeing the foregoing properties of the electrode plate, this application does not affect efficiency of the cold pressing manufacturing process of the electrode plate, which is of great significance for actual industrial application.

### BRIEF DESCRIPTION OF DRAWINGS

FIG. 1 is a planar view of an electrode plate structure with a functional coating and a groove (with no extension area illustrated);

FIG. 2 is a sectional view of an electrode plate structure with a functional coating and a groove (with no extension area illustrated);

FIG. 3 is a sectional view of an electrode plate structure according to an embodiment of this application;

FIG. 4 is a sectional view of an electrode plate structure according to another embodiment of this application;

FIG. 5 is a sectional view of an electrode plate structure according to still another embodiment of this application; and

FIG. 6 is a planar view of an electrode plate structure according to an embodiment of this application.

Description of reference signs: 1. current collector; 2. functional coating; 21. functional area; 22. extension area; 3. non-coating area; and W. width of extension area.

### DETAILED DESCRIPTION

To make persons skilled in the art better understand the solutions of this application, the following further describes this application in detail with reference to the accompanying drawings.

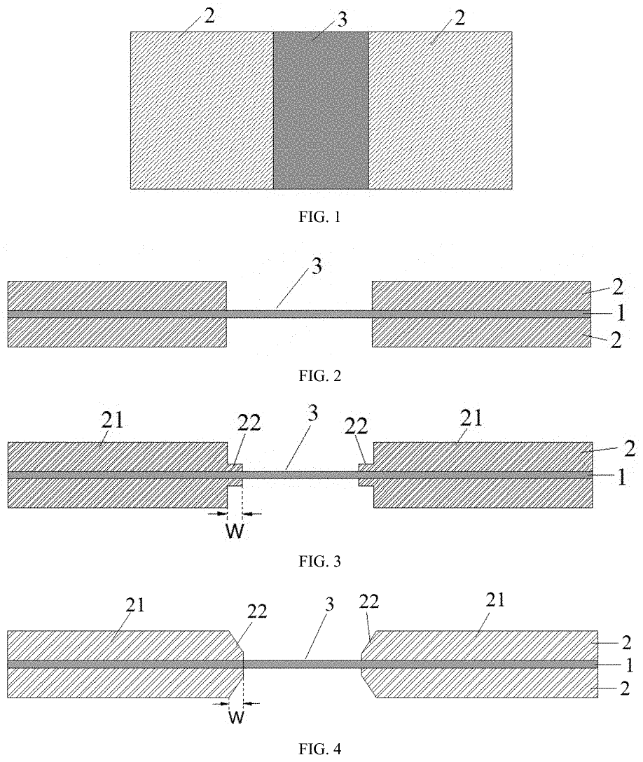

As shown in FIG. 1 to FIG. 6, the electrode plate of this application includes a current collector 1, where a functional coating 2 and a non-coating area 3 are provided on at least one surface of the current collector 1, the functional coating 2 includes a functional area 21 and an extension area 22 that extends from the functional area 21 to the non-coating area 3, and the extension area 22 has a minimum thickness (that is, thickness of the extension area 22 at a thinnest position) greater than 0 and a maximum thickness (that is, thickness of the extension area 22 at a thickest position) less than a thickness of the functional area 21.

The thickness of the extension area 22 is a perpendicular distance from a point on a surface of the extension area 22 to the current collector 1. In a specific implementation, a cross section of the extension area 22 in a thickness direction may be measured with a microscope, to determine thicknesses of the extension area 22 at different positions, for example, the maximum thickness, the minimum thickness, and following thicknesses at a ½ width position, ⅓ width position, and ⅔ width position. The implementation, however, is not limited thereto. The thickness may alternatively be measured by using other conventional methods.

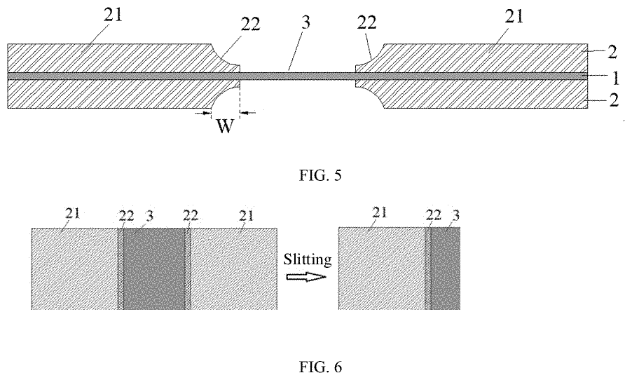

The non-coating area 3 is a naked foil area without a coating. Generally, an interface thickness of the functional coating (a sum of the thickness of the functional area 21 and the thickness of the current collector 1) may be 5 times to 20 times the thickness of the non-coating area 3 (that is, thickness of the current collector), without being limited thereto. Specifically, the non-coating area 3 may be a naked foil area reserved for welding a tab, or may be another area without a coating designed as required. In some embodiments, the non-coating area 3 includes at least one of a naked foil area that is located on a side of the functional coating 2 (as shown in FIG. 6, where the left side is a schematic structural diagram of a base material including two electrode plates; and the right side is a schematic structural diagram of the two electrode plates obtained by slitting the base material), and a groove that is provided in the functional coating 2 and that exposes a surface of the current collector (with a groove structure shown in FIG. 1 and FIG. 2), where a bottom face of the groove is the current collector, and at least two side faces of the groove are the functional coating. A cross section of the non-coating area is, for example, rectangular/square (as shown in FIG. 6), or round, or in other shapes. A quantity of the non-coating area 3 may be one or more, which may be set as required in a specific implementation.

In some embodiments, the thickness of the extension area 22 is substantially unchanged or decreasing in an extension direction toward the non-coating area 3, which helps to resolve the problem of concentrated stress in a transition area between the functional coating and the non-coating area, improve strength of the current collector, and further guarantee functioning of the electrode plate. Specifically, a thickness of the extension area 22 at a position closest to the non-coating area 3 is the minimum thickness of the extension area 22, and a thickness thereof at a position farthest away from the non-coating area 3 is the maximum thickness of the extension area 22. The minimum thickness of the extension area 22 is greater than 0, meaning that the extension area 22 has a side face parallel to a thickness direction of the functional coating, on a side in proximity of the non-coating area 3. In some embodiments, that a thickness of the extension area 22 is substantially unchanged in an extension direction toward the non-coating area 3 means that a thickness difference of the extension area 22 is within a range of 2 μm in the extension direction toward the non-coating area 3 (that is, a difference between the maximum thickness and the minimum thickness of the extension area 22 is within 2 μm, for example, within 1 μm or a smaller range).

For example, as shown in FIG. 3, the surface of the extension area 22 is a flat surface, meaning the thickness of the extension area 22 is unchanged in the extension direction toward the non-coating area 3, and the non-coating area 3 has an even thickness (a minimum thickness and a maximum thickness of the non-coating area 3 are substantially equal, which is defined as a thickness difference within a range of 1 μm); or as shown in FIG. 4, the surface of the extension area 22 is an inclined surface, meaning the thickness of the extension area 22 is gradually decreasing in the direction toward the non-coating area 3, with a decreasing rate unchanged; or as shown in FIG. 5, the surface of the extension area 22 is a cambered surface, which may be specifically a cambered concave surface (the cambered surface is a concave one), meaning the thickness of the extension area 22 is gradually decreasing in the direction toward the non-coating area 3, with a decreasing rate gradually reduced in the direction toward the non-coating area 3, or may be a cambered convex surface (the cambered surface is a convex one), meaning the thickness of the extension area 22 is gradually decreasing in the direction toward the non-coating area 3, with a decreasing rate gradually increased in the direction toward the non-coating area 3. In this embodiment, the accompanying drawings merely show an electrode plate structure with a cambered surface that is concave, and an electrode plate structure with a cambered surface that is convex is not shown in the accompanying drawings.

In some embodiments, in the direction from the functional area 21 to the non-coating area 3, a thickness of the extension area 22 at a ½ width position is less than a thickness at a joint of the extension area 22 and the functional area 21.

In some embodiments, in the direction from the functional area 21 to the non-coating area 3, a thickness of the extension area 22 at a 2/3 width position is less than a thickness at a ⅓ width position of the extension area 22.

In some embodiments, the functional area has an even thickness which satisfies

$$0.1 \leq \frac{{T}_{2}}{{T}_{1}} \leq 0.7 ,$$

where T₁ is the thickness of the functional area 21, T₂ is the minimum thickness of the extension area 22, and

$$\frac{{T}_{2}}{{T}_{1}}$$

is, for example, 0.1, 0.2, 0.3, 0.4, 0.5, 0.6, 0.7, or a range defined by any two of these numbers, which helps to further relieve the problem of concentrated stress in the transition area and improve properties such as energy density of the electrode plate.

The functional area 21 has an even thickness. The even thickness means that a minimum thickness and a maximum thickness of the functional area 21 are substantially equal, which is defined as a thickness difference within 3 μm, for example, within 2 μm, 1 μm, or a smaller range.

Specifically, in some embodiments, the thickness T₁ of the functional area 21 may range from 50 μm to 150 μm, for example, being 50 μm, 60 μm, 70 μm, 80 μm, 90 μm, 100 μm, 110 μm, 120 μm, 130 μm, 140 μm, 150 μm, or in a range defined by any two of these numbers, and the minimum thickness T₂ of the extension area 22 may range from 10 μm to 70 μm, for example, being 10 μm, 20 μm, 30 μm, 40 μm, 50 μm, 60 μm, 70 μm, or in a range defined by any two of these numbers.

In some embodiments, a width W of the extension area 22 ranges from 0.1 mm to 3 mm in the direction from the functional area 21 to the non-coating area 3, for example, being 0.1 mm, 0.5 mm, 1 mm, 1.5 mm, 2 mm, 2.5 mm, 3 mm, or in a range defined by any two of these numbers, which helps to relieve the problem of concentrated stress in the transition area and improve properties such as energy density of the electrode plate. Generally, within the foregoing range, a smaller W is more favorable for manufacturing the electrode plate and allows for higher machining efficiency.

In this application, the foregoing electrode plate may be a positive electrode plate or a negative electrode plate. In some embodiments, the electrode plate is a negative electrode plate that satisfies

$${T}_{1} \times CW = A \times W \times \frac{{T}_{2}}{{T}_{1}} ;$$

or the electrode plate is a positive electrode plate that satisfies

$${T}_{1} \times CW = B \times W \times \frac{{T}_{2}}{{T}_{1}} ;$$

where T₁ is the thickness of the functional area, measured in μm; T₂ is the minimum thickness of the extension area, measured in μm; W is a width of the extension area in a direction from the functional area to the non-coating area, measured in mm; CW is a surface density of the functional area, measured in mg/1540.25 mm²; A is a random number greater than or equal to 10 and less than or equal to 35; and B is a random number greater than or equal to 20 and less than or equal to 60. According to research on this application, this condition helps further relieve the problem of concentrated stress in the transition area, improve strength of the current collector, and further guarantee functioning of the electrode plate.

This application may use a conventional current collector in the art. For example, when the foregoing electrode plate is a positive electrode plate, the current collector may be aluminum foil; and when the foregoing electrode plate is a negative electrode plate, the current collector may be copper foil, or the like.

In this application, the functional coating 2 and the non-coating area 3 may be provided on only one surface of the current collector 1, or the functional coating 2 and the non-coating area 3 may be provided on both front and back surfaces of the current collector 1. Comparatively, the latter case better improves properties such as energy density of the electrode plate. In a specific implementation, the two cases may be selected as required. For example, in some embodiments, two surfaces of the current collector 1 each include a functional coating 2 and a non-coating area 3, where the functional coatings 2 on the two surfaces of the current collector 1 are corresponding in position, and the non-coating areas 3 on the two surfaces of the current collector 1 are corresponding in position. That is, a direct projection of the functional coating 2 on one surface of the current collector 1 parallel to a surface of the electrode plate coincides with a positive projection of the functional coating 2 on the other surface of the current collector 1 parallel to the surface of the electrode plate, and a direct projection of the non-coating area 3 on one surface of the current collector 1 parallel to the surface of the current collector 1 coincides with a direct projection of the non-coating area 3 on the other surface of the current collector 1 parallel to the surface of the current collector (as shown in FIG. 3 to FIG. 5), where the functional areas on the two front and back surfaces of the current collector are corresponding in position, and extension areas on two front and back surfaces of the current collector are corresponding in position. The implementation, however, is not limited thereto. The functional coating and the non-coating area may be provided on other positions of the front and back surfaces of the current collector as required, as long as the foregoing extension area is present between the functional area and the non-coating area.

In this application, the functional coating includes, for example, an active substance layer, and may further include, as required, other coatings such as a protection layer fitting with the active substance layer. In some embodiments, the functional area and the extension area each include an active substance, a conductive agent, and a binder, where a mass percentage of the active substance ranges from 85% to 98%, a mass percentage of the conductive agent ranges from 0.01% to 3%, and a mass percentage of the binder ranges from 0.1% to 5%. The functional area and the extension area may have the same or different constituents and the same or different amounts of constituents, and preferably the same in general, to help relieve the problem of concentrated stress in the transition area and simplify a manufacturing process of the electrode plate.

In this application, for example, the conductive agent may include at least one of conductive carbon black (SP), acetylene black, Ketjen black, carbon fiber, and the like. The binder may include at least one of polyvinylidene fluoride (PVDF), polyvinyl alcohol, hydroxypropyl cellulose, diacetyl cellulose, polyvinyl chloride, carboxylated polyvinyl chloride, polyvinyl fluoride, ethylidene-containing oxide polymer, polyvinylpyrrolidone, polyurethane, polytetrafluoroethylene, poly(vinylidene fluoride), polyethylene, polypropylene, styrene-butadiene rubber (SBR), acrylic styrene-butadiene rubber, epoxy resin, nylon, and the like. When the electrode plate is a positive electrode plate, the active substance may include at least one of lithium cobalt oxide (LCO), lithium iron phosphate (LFP), lithium manganate, nickel-cobalt-manganese (NCM) ternary material, and nickel-cobalt-aluminum (NCA) ternary material. When the electrode plate is a negative electrode plate, the active substance may include at least one of graphite, mesocarbon microbead (MCMB), hard carbon, soft carbon, silicon, and silicon-carbon compound (or referred to as silicon carbon compound). The graphite may specifically include artificial graphite and/or natural graphite.

The electrode plate of this application may be manufactured by a conventional method in the art. For example, a slurry containing a functional coating component may be coated on a surface of a metal foil material (a current collector), followed by drying and rolling, to form a functional coating on the surface of the metal foil material; then, based on a preset position of the non-coating area, a coating on the preset position of the non-coating area is removed by laser cleaning or the like to expose a surface of the current collector and form the non-coating area, meanwhile a part of the functional coating in proximity of the non-coating area is thinned according to parameters such as shape of the extension area, to form the extension area, and then slitting is performed according to parameters such as preset shape and size of the electrode plate, to obtain electrode plates.

An electrochemical apparatus of this application includes the foregoing electrode plate. The electrochemical apparatus may be any apparatus in which electrochemical reaction takes place, and may be particularly an electrochemical apparatus that includes a positive electrode with a positive electrode active substance which is capable of occluding and releasing metal ions (such as lithium ions), and a negative electrode with a negative electrode active substance which is capable of occluding and releasing metal ions. Specific examples of the electrochemical apparatus may be all types of primary batteries, secondary batteries, fuel batteries, solar batteries, or capacitors, and particularly, the electrochemical apparatus may be a lithium-ion secondary battery.

The foregoing electrode plate may be a positive electrode plate, or may be a negative electrode plate, or may include a positive electrode plate and a negative electrode plate. When the electrode plate is a positive electrode plate, the electrochemical apparatus further includes a negative electrode plate, where the negative electrode plate may be a conventional negative electrode plate in the art such as a graphite-containing negative electrode plate and a silicon-containing negative electrode plate; and when the electrode plate is a negative electrode plate, the electrochemical apparatus further includes a positive electrode plate, where the positive electrode plate may be a conventional positive electrode plate in the art. This is not specifically limited in this application.

The electrochemical apparatus further includes a separator located between the positive electrode plate and the negative electrode plate, where the separator is configured to separate the positive electrode plate and the negative electrode plate, and may be a conventional separator in the art. This is not specifically limited in this application.

An electronic apparatus of this application includes the foregoing electrochemical apparatus which is used as an energy storage apparatus.

To make the objectives, technical solutions and advantages of this application clearer, the following further describes this application with reference to the specific examples and comparative examples of this application. Apparently, the described examples are some but not all of the examples of this application. All other embodiments obtained by a person of ordinary skill in the art based on the examples of this application without creative efforts shall fall within the protection scope of this application.

In the following examples and comparative examples, tensile strength of a cold-pressed electrode plate was determined according to the following process: adjusting positions of an upper clamp and a lower clamp, clamping an electrode plate sample with forceps into the clamps, adjusting tension software so as to elongate the electrode plate at a stable speed of 20 mm/min, recording a maximum load p at a shear failure, and calculating the tensile strength of the electrode plate according to the equation: tensile strength=p/(width w of electrode plate sample x thickness h of electrode plate sample). The same electrode plate was tested multiple times according to this process, to obtain average tensile strength N of the electrode plate (N is an average found from the multiple tests).

### EXAMPLES

(1) Negative Electrode Plates Provided in the Following Examples 1 to 5 were Manufactured According to the Following Process.

To deionized water, 96% by mass of graphite, 1% by mass of carbon blank, and 3% by mass of styrene-butadiene rubber were added and mixed to prepare a negative electrode slurry; the negative electrode slurry was coated on a surface of a copper foil, followed by drying and rolling, to form a negative electrode active substance layer on the surface of the copper foil; and a groove for mounting a negative tab and exposing the surface of the copper foil was cut into the negative electrode active substance layer by laser cleaning (as shown in FIG. 1 and FIG. 2), and a part of the negative electrode active substance layer in proximity of the groove was thinned to form an extension area (as shown in FIG. 3 to FIG. 5), to prepare a negative electrode plate.

(2) Positive Electrode Plates Provided in the Following Examples 6 to 10 were Manufactured According to the Following Process.

To N-methylpyrrolidone, 95% by mass of lithium cobalt oxide, 2% by mass of carbon blank, and 3% by mass of polyvinylidene fluoride were added and mixed to prepare a positive electrode slurry; the positive electrode slurry was coated on a surface of an aluminum foil, followed by drying and rolling, to form a positive electrode active substance layer on the surface of the aluminum foil; and a groove for mounting a positive tab and exposing the surface of the aluminum foil was cut into the positive electrode active substance layer by laser cleaning (as shown in FIG. 1 and FIG. 2), and a part of the positive electrode active substance layer in proximity of the groove was thinned to form an extension area (as shown in FIG. 3 to FIG. 5), to prepare a positive electrode plate.

### Comparative Example 1

A negative electrode plate structure provided in comparative example 1 is the same as those in examples 1 to 5 except that no extension area is provided between the functional area and the groove.

### Comparative Example 2

A positive electrode plate structure provided in comparative example 2 is the same as those in Examples 6 to 10 except that no extension area is provided between the functional area and the groove.

Table 1 gives the extension area surface states (flat surface shown in FIG. 3/inclined surface shown in FIG. 4/cambered concave surface shown in FIG. 5), extension area minimum thicknesses T₂, extension area widths W, functional area thicknesses T₁, and measured tensile strengths of electrode plates in examples 1 to 5 and comparative example 1.

Table 2 gives the extension area surface state (flat surface/inclined surface/cambered concave surface), extension area minimum thicknesses T₂, extension area widths W, functional area thicknesses T₁, and measured tensile strengths of electrode plates in examples 6 to 10 and comparative example 2.

TABLE 1
Parameters and tensile strengths of negative electrode
plates in examples 1 to 5 and comparative example 1

| | | | | | Extension | |
|---|---|---|---|---|---|---|
| | | CW | | | area | Tensile |
| | T₁ | (g/1540.25 | W | T₂ | surface | strength* |
| Examples | (μm) | mm²) | (mm) | (μm) | state | (MPa) |
| Comparative | 100 | 0.130 | 0 | 0 | / | 352 |
| Example 1 | | | | | | |
| Example 1 | 100 | 0.130 | 1.25 | 50 | See FIG. | 436 |
| | | | | | 3. | |
| Example 2 | 100 | 0.130 | 1.25 | 50 | See FIG. | 432 |
| | | | | | 4. | |
| Example 3 | 100 | 0.130 | 1.25 | 50 | See FIG. | 430 |
| | | | | | 5. | |
| Example 4 | 100 | 0.130 | 3 | 5 | See FIG. | 372 |
| | | | | | 3. | |
| Example 5 | 100 | 0.130 | 3 | 80 | See FIG. | 367 |
| | | | | | 3. | |

TABLE 2
Parameters and tensile strengths of positive electrode
plates in examples 6 to 10 and comparative example 2

| | | | | | Extension | |
|---|---|---|---|---|---|---|
| | | CW | | | area | Tensile |
| | T₁ | (g/1540.25 | W | T₂ | surface | strength |
| Examples | (μm) | mm²) | (mm) | (μm) | state | (MPa) |
| Comparative | 88 | 0.250 | 0 | 0 | / | 210 |
| example 2 | | | | | | |
| Example 6 | 88 | 0.250 | 1.25 | 40 | See FIG. | 287 |
| | | | | | 3. | |
| Example 7 | 88 | 0.250 | 1.25 | 40 | See FIG. | 271 |
| | | | | | 4. | |
| Example 8 | 88 | 0.250 | 1.25 | 40 | See FIG. | 268 |
| | | | | | 5. | |
| Example 9 | 88 | 0.250 | 3 | 5 | See FIG. | 234 |
| | | | | | 3. | |
| Example 10 | 88 | 0.250 | 3 | 70 | See FIG. | 225 |
| | | | | | 3. | |

According to the test results, the tensile strengths of the negative electrode plates in examples 1 to 5 are significantly higher than that of the negative electrode plate in comparative example 1, and the tensile strengths of the positive electrode plates in examples 6 to 10 are significantly higher than that of the positive electrode plate in comparative example 2. Particularly, the strength of the electrode plate is even more improved in examples 1 to 3 and examples 6 to 8. This shows that after the extension area is added, concentrated stress on the electrode plate that is being cold-pressed is greatly reduced, which accordingly reduces deformation of the transition area and allows for excellent tensile strength of the cold-pressed electrode plate.

The foregoing describes examples of specific embodiments and experimental verification of this application in detail. It should be understood that a person of ordinary skill in the art can make various modifications and variations based on the concept of this application without creative efforts. Any technical solutions that can be obtained by persons skilled in the art through logical analysis, reasoning, or limited experiments based on the concept of this application on the basis of the prior art shall fall within the protection scope defined by the claims.

What is claimed is:

1. An electrode plate, comprising: a current collector, wherein a functional coating and a non-coating area are provided on at least one surface of the current collector, the functional coating comprises a functional area and an extension area that extends from the functional area to the non-coating area, and the extension area has a minimum thickness greater than 0 and a maximum thickness less than a thickness of the functional area.

2. The electrode plate according to claim 1, wherein the non-coating area comprises at least one of a naked foil area located on a side of the functional coating, and a groove provided in the functional coating and the groove exposes a surface of the current collector, wherein a bottom face of the groove is the current collector, and at least two side faces of the groove are the functional coating.

3. The electrode plate according to claim 1, wherein a thickness of the extension area is substantially unchanged or decreasing in an extension direction toward the non-coating area.

4. The electrode plate according to claim 1, wherein a width of the extension area ranges from 0.1 mm to 3 mm in a direction from the functional area to the non-coating area.

5. The electrode plate according to claim 2, wherein a width of the extension area ranges from 0.1 mm to 3 mm in a direction from the functional area to the non-coating area.

6. The electrode plate according to claim 3, wherein a width of the extension area ranges from 0.1 mm to 3 mm in a direction from the functional area to the non-coating area.

7. The electrode plate according to claim 4, wherein in the direction from the functional area to the non-coating area, a thickness of the extension area at a ½ width position is less than a thickness at a joint of the extension area and the functional area.

8. The electrode plate according to claim 1, wherein a surface of the extension area is one of a flat surface, an inclined surface, and a cambered surface.

9. The electrode plate according to claim 2, wherein a surface of the extension area is one of a flat surface, an inclined surface, and a cambered surface.

10. The electrode plate according to claim 3, wherein a surface of the extension area is one of a flat surface, an inclined surface, and a cambered surface.

11. The electrode plate according to claim 1, wherein the functional area has an even thickness and
$$0.1 \leq \frac{{T}_{2}}{{T}_{1}} \leq 0.7 ,$$
wherein T₁ is the thickness of the functional area, and T₂ is the minimum thickness of the extension area.

12. The electrode plate according to claim 4, wherein the functional area has an even thickness and
$$0.1 \leq \frac{{T}_{2}}{{T}_{1}} \leq 0.7 ,$$
wherein T₁ is the thickness of the functional area, and T₂ is the minimum thickness of the extension area.

13. The electrode plate according to claim 1, wherein at least one of the following conditions is satisfied:
the thickness of the functional area ranges from 50 μm to 150 μm; and
the minimum thickness of the extension area ranges from 10 μm to 70 μm.

14. The electrode plate according to claim 11, wherein at least one of the following conditions is satisfied:
the thickness of the functional area ranges from 50 μm to 150 μm; and
the minimum thickness of the extension area ranges from 10 μm to 70 μm.

15. The electrode plate according to claim 1, wherein
the electrode plate is a negative electrode plate that satisfies
$${T}_{1} \times CW = A \times W \times \frac{{T}_{2}}{{T}_{1}} ;$$
or
the electrode plate is a positive electrode plate that satisfies
$${T}_{1} \times CW = B \times W \times \frac{{T}_{2}}{{T}_{1}} ;$$
wherein
T₁ is the thickness of the functional area, measured in μm;
T₂ is the minimum thickness of the extension area, measured in μm;
W is a width of the extension area in a direction from the functional area to the non-coating area, measured in mm;
CW is a surface density of the functional area, measured in mg/1540.25 mm²;
A is a random number greater than or equal to 10 and less than or equal to 35; and
B is a random number greater than or equal to 20 and less than or equal to 60.

16. The electrode plate according to claim 13, wherein
the electrode plate is a negative electrode plate that satisfies
$${T}_{1} \times CW = A \times W \times \frac{{T}_{2}}{{T}_{1}} ;$$
or
the electrode plate is a positive electrode plate that satisfies
$${T}_{1} \times CW = B \times W \times \frac{{T}_{2}}{{T}_{1}} ;$$
wherein
T₁ is the thickness of the functional area, measured in μm;
T₂ is the minimum thickness of the extension area, measured in μm;
W is a width of the extension area in a direction from the functional area to the non-coating area, measured in mm;
CW is a surface density of the functional area, measured in mg/1540.25 mm²;
A is a random number greater than or equal to 10 and less than or equal to 35; and
B is a random number greater than or equal to 20 and less than or equal to 60.

17. The electrode plate according to claim 14, wherein
the electrode plate is a negative electrode plate that satisfies
$${T}_{1} \times CW = A \times W \times \frac{{T}_{2}}{{T}_{1}} ;$$
or
the electrode plate is a positive electrode plate that satisfies
$${T}_{1} \times CW = B \times W \times \frac{{T}_{2}}{{T}_{1}} ;$$
wherein
T₁ is the thickness of the functional area, measured in μm;
T₂ is the minimum thickness of the extension area, measured in μm;
W is a width of the extension area in a direction from the functional area to the non-coating area, measured in mm;
CW is a surface density of the functional area, measured in mg/1540.25 mm²;
A is a random number greater than or equal to 10 and less than or equal to 35; and
B is a random number greater than or equal to 20 and less than or equal to 60.

18. An electrochemical apparatus, comprising the electrode plate according to claim 1.

19. An electronic apparatus, comprising the electrochemical apparatus according to claim 18.
